(19) United States
(12) Patent Application Publication
(10) Pub. No.: US 2026/0203344 A1
(43) Pub. Date: Jul. 16, 2026

(54) MEDIA DEVICE PLAYLIST DATA

(71) Applicant: Walmart Apollo, LLC, Bentonville, AR (US)

(72) Inventors: Jianqiu Lu, Campbell, CA (US); Wentong Li, Saratoga, CA (US)

(21) Appl. No.: 19/020,834

(22) Filed: Jan. 14, 2025

(51) Int. Cl. G06F 16/438; G06Q 30/0242; G06Q 30/0273

(52) U.S. Cl. CPC G06F 16/4387; G06Q 30/0246; G06Q 30/0273

(57) ABSTRACT

Examples may be related to playlist data for media devices. An example may involve receiving a network request including at least one campaign reservation request; generating, based on the network request, playlist data associated with a time period and a physical store; and determining one or more media devices that are located at the physical store and are available to display the playlist during the time period. The playlist data may be transmitted to the one or more media devices for displaying the playlist on the one or more media devices within the time period.

### BACKGROUND

Media devices, e.g., televisions, department screen and projectors, may be located at different physical locations, such as at different departments across a physical store. Such media devices may be connected to a network and may be used to display various information, including videos, advertisements, and other media content.

### BRIEF DESCRIPTION OF THE DRAWINGS

Various examples will be described by the following detailed description of the example embodiments, which is to be considered together with the accompanying drawings wherein like numbers refer to like parts and further wherein:

FIG. 1 is a network environment configured for generating and serving in-store advertisements, in accordance with some embodiments;

FIG. 2 is a block diagram of an in-store advertisement computing device, in accordance with some embodiments;

FIG. 3 is a block diagram illustrating various portions of a system for generating and serving in-store advertisements, in accordance with some embodiments;

FIG. 4 illustrates an example architecture of a system for generating and serving in-store advertisements, in accordance with some embodiments;

FIG. 5 is a block diagram illustrating various portions of a device management system, in accordance with some embodiments;

FIG. 6 shows a flowchart illustrating an example method for generating and serving in-store advertisements, in accordance with some embodiments;

FIG. 7 shows a flowchart illustrating an example method for generating playlist data, in accordance with some embodiments;

FIG. 8 shows a flowchart illustrating an example method for obtaining inventory information, in accordance with some embodiments;

FIG. 9 shows a flowchart illustrating an example method for determining a section of a physical store, in accordance with some embodiments;

FIG. 10 shows a flowchart illustrating an example method for generating and transmitting billing information, in accordance with some embodiments;

FIG. 11 depicts an example system with a machine-readable medium that includes instructions for generating and serving in-store advertisements, in accordance with some embodiments.

### DETAILED DESCRIPTION

This description of the example embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

A retailer may desire to build an operationally efficient, reliable and extendable platform that can enable suppliers and sellers to engage with customers through consistent, impactful and measurable activations across a network of stores of the retailer. One objective of various embodiments in the present disclosure is to automate an in-store advertisement workflow, which can provide flexible advertisement targeting, provide insights of device supply and inventory availability, improve system operability and optimize performance through real-time bidding and reporting, and seamlessly scale to all display devices through a reliable device management system.

In some embodiments, a campaign manager or an account manager can check inventory availability and price information for displaying advertisements on in-store media devices, and may reserve in-store advertising campaigns through a user interface provided by a disclosed system. In addition, the campaign manager or account manager can provide an invoice and measurement report to an advertiser. In some embodiments, a self-serve advertiser can check inventory availability and price information, and can reserve in-store advertising campaigns and access the invoice and measurement reports through a user interface of the system. In some embodiments, an associate can check inventory availabilities, simulate campaign reservations and check pricing through a user interface of the system.

In some embodiments, an advertising campaign can be automatically created by a disclosed system in response to a campaign reservation request. In some embodiments, the system includes a device manager configured to monitor health data of media devices and screens in the network of stores. Upon detecting any health issue of a device, the system may automatically generate an alert to instruct a service system to perform remote diagnosis and resolve the issue.

In some embodiments, the system can leverage a first-party display advertising platform, a domain model, a data pipeline, a billing system and other components to create a unified advertising experience. The system can scale to any media device type across all stores, and may support multiple content advertising models. The system can enable a campaign manager to book a campaign with flexible targets, at a time length, a specified time and/or a specified day. The system may provide insights of inventory availability of media devices for advertisement displaying at different granularity levels (e.g. department level, store level, region level, state level, etc.).

In some embodiments, the system generates a playlist of advertisements in a given time length, e.g. one hour, for scheduling one or more media devices to display the playlist of advertisement within the time length. The system can manage all the contents displayed on the media devices, including advertisements, promotion contents and public service announcement (PSA). Content may be cached on an in-store media device before being displayed.

In some embodiments, a player device in a store can query an advertisement server periodically (e.g. at an interval of 5 or 10 minutes) for a playlist. In some embodiments, the playlist can indicate a section in the store, corresponding to a product department or a product category in the store. The player device may be stateless and play the contents from a time offset in the playlist via one or more media devices in the section of the store. The store may also include a device management system for capturing and detecting any error from the media devices, giving a best effort to auto recover, and/or sending alerts. In some examples, the playlist may include advertisements in various formats, e.g. video advertisements and static advertisements.

In some embodiments, the disclosed system can provide advertising service in any store in the network, and may scale to all stores of the network and beyond. The system can power all feasible in-store screens in all departments of a store. The system may perform campaign reservation, advertisement bidding and reporting in real-time, with secure network communications. In some embodiments, a campaign report may include insight data of the campaign, e.g. human impression counting information based on estimated foot traffic data associated with the one or more media devices displaying advertisements of the campaign.

In various embodiments, a system including a processor and a non-transitory memory storing instructions is disclosed. The instructions, when executed, cause the processor to: receive a network request including at least one campaign reservation request; generate, based on the network request, playlist data indicating a playlist of advertisements associated with a time period and a physical store; determine one or more media devices that are located at the physical store and are available to display the playlist of advertisements during the time period; and transmit the playlist data to the one or more media devices for displaying the playlist of advertisements on the one or more media devices within the time period.

In various embodiments, a computer-implemented method is disclosed. The computer-implemented method includes: receiving a network request including at least one campaign reservation request; generating, based on the network request, playlist data indicating a playlist of advertisements associated with a time period and a physical store; determining one or more media devices that are located at the physical store and are available to display the playlist of advertisements during the time period; and transmitting the playlist data to the one or more media devices for displaying the playlist of advertisements on the one or more media devices within the time period.

In various embodiments, a non-transitory computer readable medium having instructions stored thereon is disclosed. The instructions, when executed by at least one processor, cause at least one device to perform operations including: receiving a network request including at least one campaign reservation request; generating, based on the network request, playlist data indicating a playlist of advertisements associated with a time period and a physical store; determining one or more media devices that are located at the physical store and are available to display the playlist of advertisements during the time period; and transmitting the playlist data to the one or more media devices for displaying the playlist of advertisements on the one or more media devices within the time period.

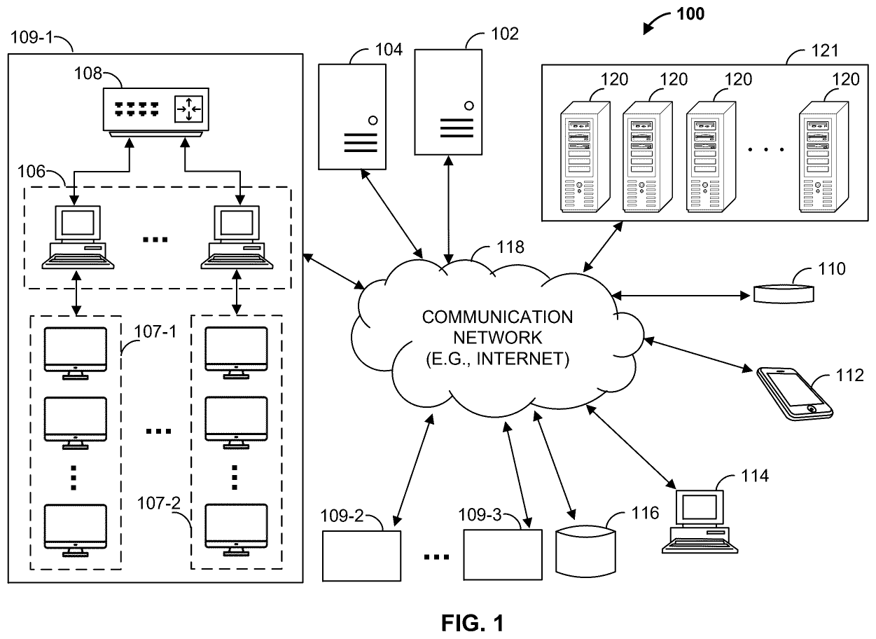

Turning to the drawings, FIG. 1 is a network environment 100 configured for generating and serving in-store advertisements, in accordance with some embodiments. The network environment 100 includes a plurality of devices or systems that can communicate over one or more network channels, illustrated as a network cloud 118. For example, in various embodiments, the network environment 100 can include, but not limited to, an in-store advertisement computing device 102, a server 104 (e.g., a web server or an application server), a cloud-based engine 121 including one or more processing devices 120, workstation(s) 106, media devices 107-1, 107-2, a database 116, and one or more user computing devices 110, 112, 114 operatively coupled over the network 118. The in-store advertisement computing device 102, the server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the in-store advertisement computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more Tensor Processing Units (TPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the in-store advertisement computing device 102.

In some examples, each of the multiple user computing devices 110, 112, 114 can be a cellular phone, a smart phone, a tablet, a personal assistant device, a voice assistant device, a digital assistant, a laptop, a computer, a laser-based code scanner, or any other suitable device. In some examples, the server 104 hosts one or more websites or apps providing one or more products or services. In some examples, the in-store advertisement computing device 102, the processing devices 120, and/or the server 104 are operated by a corporation, e.g. a big retailer, and the multiple user computing devices 110, 112, 114 are operated by customers, advertisers, associates or managers of the corporation. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a fulfillment node 109-1 of a retailer, for example. The fulfillment node 109-1 may be a store, a warehouse, a fulfillment center or a distribution center of the retailer. At the same time, the retailer may also include other fulfillment nodes 109-2, 109-3, each of which is also associated with one or more workstation(s) similarly to the fulfillment node 109-1. The fulfillment nodes 109-1, 109-2, 109-3 will be together referred to as fulfillment nodes 109 (or nodes 109).

The workstation(s) 106 may communicate with the media devices 107-1, 107-2, which are media devices in different sections of the fulfillment node 109-1. For example, when the fulfillment node 109-1 is a physical store, each of the workstations 106 may communicate with media devices 107-1, 107-2 in a corresponding product category section (e.g. electronics, pharmacy, deli, etc.) of the store. For example, the media devices 107-1 may be televisions or computer display monitors for displaying advertisements in an electronics section of the store 109-1, while the media devices 107-2 may be televisions or computer display monitors for displaying advertisements in a pharmacy section of the store 109-1. In some examples, the workstation(s) 106 may send playlist data to the media devices 107-1, 107-2. In some examples, the workstation(s) 106 may monitor device health and status of the media devices 107-1, 107-2.

The workstation(s) 106 can communicate with the in-store advertisement computing device 102 over the communication network 118. The workstation(s) 106 may send data to, and receive data from, the in-store advertisement computing device 102. For example, the workstation(s) 106 may transmit data identifying transactions, inventory, assortment, supply chain data and/or waste data at the one or more fulfillment nodes 109 to the in-store advertisement computing device 102. The workstation(s) 106 may also transmit other data related to the one or more fulfillment nodes 109 to the in-store advertisement computing device 102.

Although FIG. 1 illustrates three user computing devices 110, 112, 114, the network environment 100 can include any number of user computing devices 110, 112, 114. Similarly, the network environment 100 can include any number of the in-store advertisement computing devices 102, the processing devices 120, the workstations 106, the fulfillment nodes 109, the servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the server 104 over the communication network 118. For example, one of the multiple user computing devices 110, 112, 114 may be operable to view, access, and interact with a website, such as a retailer's website, hosted by the server 104. The server 104 may capture user session data related to a customer's activity (e.g., interactions) on the website. For example, a customer may operate one of the user computing devices 110, 112, 114 to initiate a web browser that is directed to the website hosted by the server 104. The customer may, via the web browser, search for items, view item advertisements for items displayed on the website, and click on item advertisements and/or items in the search result, for example. The website may capture these activities as user session data, and transmit the user session data to the in-store advertisement computing device 102 over the communication network 118. The website may also allow the customer to add one or more of the items to an online shopping cart, and allow the customer to perform a “checkout” of the shopping cart to purchase the items. In some examples, the server 104 transmits purchase data identifying items the customer has purchased from the website to the in-store advertisement computing device 102.

In some examples, the server 104 transmits a network request to the in-store advertisement computing device 102. The network request may include at least one campaign reservation request for reserving an advertising campaign for an advertiser.

In some examples, an advertiser may check inventory availability and price information for displaying advertisements in one or more physical stores of a retailer associated with the server 104, e.g. via a user interface served by the server 104. For example, the user interface may present how many eligible devices in each physical store are available for displaying advertisements in a given time period, and an estimated price for displaying advertisements in the physical store or in a section of the physical store. The advertiser may submit a campaign reservation request via the user interface to reserve an in-store advertising campaign. For example, the in-store advertising campaign may be associated with one or more advertisements to be displayed in a specified section of a specified physical store within a specified time period. In some examples, the specified physical store may be determined based on location information associated with the campaign reservation request. In some examples, the specified section may be determined based on product information associated with the campaign reservation request. In some examples, the specified time period may be determined based on the location information and the product information associated with the campaign reservation request.

After the server 104 sends a network request including the campaign reservation request to the in-store advertisement computing device 102, the in-store advertisement computing device 102 may execute the one or more processors to generate the in-store advertising campaign. The in-store advertisement computing device 102 can transmit campaign and billing data related to the in-store advertising campaign to the server 104. The campaign and billing data may include information related to an advertisement play history, corresponding invoices and reports of the in-store advertising campaign. The advertiser may access the campaign and billing data through the user interface associated with the server 104.

In some examples, upon a request from an advertiser, a campaign manager, an account manager or the server 104 itself can automatically check inventory availability and price information for displaying advertisements on in-store media devices in one or more physical stores of the retailer associated with the server 104. For example, the server 104 may generate a campaign reservation request based on the check inventory availability and price information for the advertiser, and sends the campaign reservation request to the in-store advertisement computing device 102, which will generate an in-store advertising campaign automatically for the advertiser. In some examples, after playing advertisements for the in-store advertising campaign, the campaign manager, the account manager or the server 104 itself can provide an invoice and measurement report to the advertiser.

In some examples, the in-store advertisement computing device 102 may generate advertising campaigns for multiple advertisers. The advertising campaigns may be associated with multiple stores. Each store may also be associated with multiple advertising campaigns.

In some embodiments, a physical store (e.g. the node 109-1) may send a playlist request to the in-store advertisement computing device 102, to query for a playlist of advertisements associated with a future time period and the physical store 109-1. The in-store advertisement computing device 102 can generate playlist data indicating the playlist of advertisements to be displayed on one or more media devices in the physical store 109-1 within the time period. The one or more media devices may be located at the physical store 109-1 and are available to display the playlist of advertisements during the time period. For example, the one or more media devices may be at least part of the media devices 107-1 in a corresponding section of the physical store 109-1. The in-store advertisement computing device 102 can transmit the playlist data to the physical store 109-1, or directly to the one or more media devices, for displaying the playlist of advertisements on the one or more media devices within the time period.

In some embodiments, the in-store advertisement computing device 102 is further operable to communicate with the database 116 over the communication network 118. For example, the in-store advertisement computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the in-store advertisement computing device 102, in some examples, the database 116 can be a local storage device, such as a hard drive, a non-volatile memory, or a USB stick. For example, the in-store advertisement computing device 102 may store online purchase data received from the server 104 in the database 116. The in-store advertisement computing device 102 may receive in-store purchase data and node related data from different fulfillment nodes 109 and store them in the database 116. The in-store advertisement computing device 102 may also receive from the server 104 user session data identifying events associated with browsing sessions, and may store the user session data in the database 116. The in-store advertisement computing device 102 may also generate campaign data (or playlist data) in response to a network request received from the server 104 (or the fulfillment nodes 109), and may store the generated data in the database 116.

In some examples, the in-store advertisement computing device 102 generates and/or updates different models (e.g., machine learning models, deep learning models, statistical models, algorithms, natural language models, etc.) for generating and serving in-store advertisements. The in-store advertisement computing device 102 may generate training data for the models based on data including but not limited to: item features, advertisement features, campaign features, media device features, store features, section features, historical advertisement display data, and historical feedback data. The in-store advertisement computing device 102 trains the models based on their corresponding training data, and stores the models in a database, such as in the database 116 (e.g., a cloud storage). The models, when executed by the in-store advertisement computing device 102, allow the in-store advertisement computing device 102 to generate playlist data, which may include a playlist of advertisements to be displayed in a physical store in a future time period.

In some examples, the in-store advertisement computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the in-store advertisement computing device 102 may generate playlist data and/or campaign data.

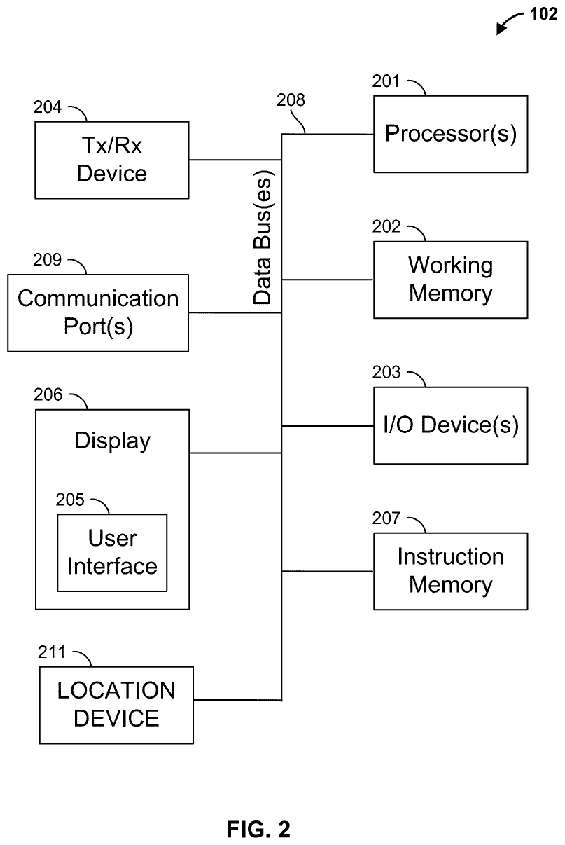

FIG. 2 illustrates a block diagram of an in-store advertisement computing device, e.g. the in-store advertisement computing device 102 of FIG. 1, in accordance with some embodiments. In some embodiments, each of the in-store advertisement computing device 102, the server 104, the workstation(s) 106, the multiple user computing devices 110, 112, 114, and the one or more processing devices 120 in FIG. 1 may include the features shown in FIG. 2. Although FIG. 2 is described with respect to certain components shown therein, it will be appreciated that the elements of the in-store advertisement computing device 102 can be combined, omitted, and/or replicated. In addition, it will be appreciated that additional elements other than those illustrated in FIG. 2 can be added to the in-store advertisement computing device 102.

As shown in FIG. 2, the in-store advertisement computing device 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the in-store advertisement computing device 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 can implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can perform a certain function or operation by executing code, stored on the instruction memory 207, embodying the function or operation. For example, the one or more processors 201 can execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the in-store advertisement computing device 102 can include a single memory unit to operate as both instruction memory and working memory. Further, although embodiments are discussed herein including non-volatile memory, it will be appreciated that the in-store advertisement computing device 102 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, Javascript, C, C++, C #, Python, Objective-C, Visual Basic, .NET, HTML, CSS, SQL, NoSQL, Rust, Perl, etc. In some embodiments, a compiler or interpreter can convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 allows communications with the cellular network. In some embodiments, the transceiver 204 is selected based on the type of the communication network 118 the in-store advertisement computing device 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the in-store advertisement computing device 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 may couple the in-store advertisement computing device 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 can utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the in-store advertisement computing device 102 and/or the server 104. For example, the user interface 205 can be a user interface for an application of a network environment operator that allows a customer to view and interact with the operator's website. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device that receives position data identifying a latitude and longitude from one or more satellites of a GPS constellation. As another example, in some embodiments, the location device 211 is a cellular device that receives location data from one or more localized cellular towers. Based on the position data, the in-store advertisement computing device 102 may determine a local geographical area (e.g., town, city, state, etc.) of its position.

In some embodiments, the in-store advertisement computing device 102 can implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

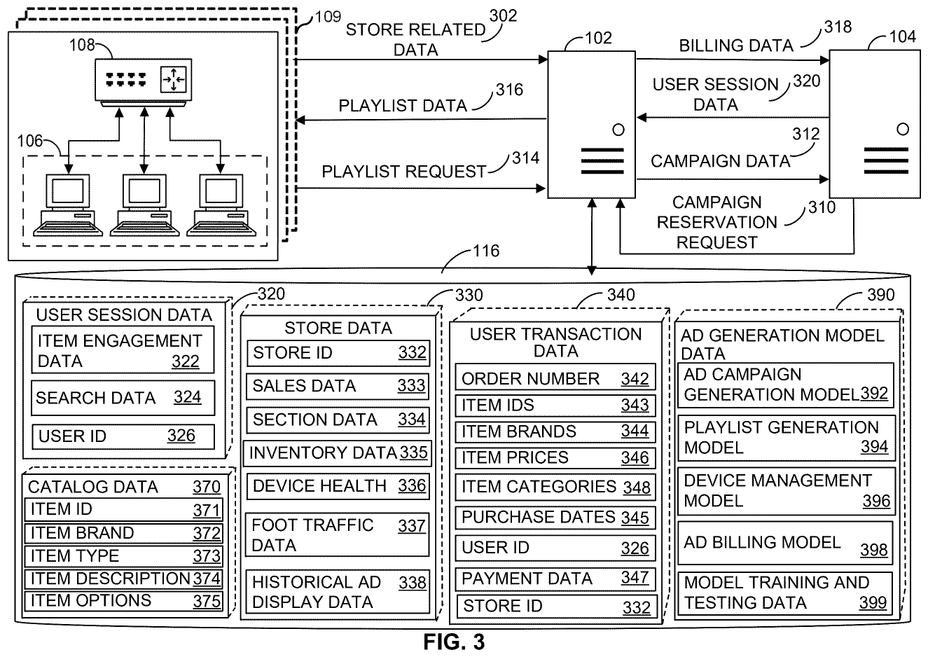

FIG. 3 is a block diagram illustrating various portions of a system for generating and serving in-store advertisements, e.g. the system shown in the network environment 100 of FIG. 1, in accordance with some embodiments. As indicated in FIG. 3, the in-store advertisement computing device 102 may receive user session data 320 from the server 104, and store the user session data 320 in the database 116. The user session data 320 may identify, for each user (e.g., advertiser, seller, customer), data related to that user's browsing session, such as when browsing a retailer's webpage hosted by the server 104. In some embodiments, the system may not utilize all of the components and data shown in FIG. 3 for generating and serving in-store advertisements.

In some examples, the user session data 320 may include item engagement data 322, search data 324, and user ID 326 (e.g., an advertiser ID, a customer ID, seller ID, associate ID, retailer website login ID, a cookie ID, etc.). The item engagement data 322 may include one or more of: a session ID (i.e., a website browsing session identifier), item clicks identifying items which a user clicked (e.g., images of items for purchase, keywords to filter reviews for an item), items viewed by the user, items added-to-cart identifying items added to the user's online shopping cart, advertisements viewed identifying advertisements the user viewed during the browsing session, or advertisements clicked identifying advertisements the user clicked on. The search data 324 may identify one or more searches conducted by a user during a browsing session (e.g., a current browsing session).

The in-store advertisement computing device 102 may also receive store related data 302 from the fulfillment nodes 109, which identifies and characterizes one or more in-store purchases, product location data, product and device inventory data, and/or assortment data related to each of the fulfillment nodes 109. In some embodiments, the store related data 302 may also indicate other information about the fulfillment nodes 109. The in-store advertisement computing device 102 may also receive online purchase data from the server 104. In some embodiments, the fulfillment nodes 109 and the server 104 are associated with each other such that the online purchase data, the user session data 320 and the store related data 302 all come from a same server cluster or datacenter.

The in-store advertisement computing device 102 may parse the store related data 302 and the online purchase data to generate user transaction data 340. In this example, the user transaction data 340 may include, for each purchase, one or more of: an order number 342 identifying a purchase order, item IDs 343 identifying one or more items purchased in the purchase order, item brands 344 identifying a brand for each item purchased, item prices 346 identifying the price of each item purchased, item categories 348 identifying a product type (or category) of each item purchased, purchase dates 345 identifying the purchase dates of the purchase orders, a user ID 326 for the user making the corresponding purchase, payment data 347 indicating payment methods and related information (e.g. emails associated with payment) for corresponding orders, and store ID 332 for the corresponding in-store purchase, or for the pickup store or shipping-from store associated with the corresponding online purchase.

In some embodiments, the database 116 may further store catalog data 370, which may identify one or more attributes of a plurality of items, such as a portion of or all items a retailer carries in stores and/or at e-commerce platforms. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc.).

In some examples, the in-store advertisement computing device 102 receives a network request including a campaign reservation request 310 for an advertiser interacting with a website or user interface hosted by the server 104. In response, the in-store advertisement computing device 102 generates an advertising campaign and related campaign data 312 for the advertiser. Then, the in-store advertisement computing device 102 may generate playlist data 316 indicating a playlist of advertisements associated with a time period and a physical store. The in-store advertisement computing device 102 may determine one or more media devices that are located at the physical store and are available to display the playlist of advertisements during the time period, and transmit the playlist data to the one or more media devices for displaying the playlist of advertisements on the one or more media devices within the time period.

In some embodiments, the playlist data 316 is generated in response to a playlist request 314, which is transmitted from one of the nodes 109 (referred to as physical stores 109 from now on for example) to the in-store advertisement computing device 102. The playlist request 314 may be sent periodically, e.g. for every hour or every ten minutes. In some embodiments, the playlist data 316 is generated automatically by the in-store advertisement computing device 102, based on campaign data of one or more campaigns generated for one or more advertisers. The playlist data 316 may be generated periodically for each of the physical stores 109.

In some embodiments, the inventory level recommendation device 102 may generate store data 330 based on the store related data 302 and the playlist data 316. In some examples, the store data 330 may include, for each store, one or more of: the store ID 332 of the store, sales data 333 indicating data of historical sales for each item in the store, section data 334 indicating data of different sections or departments in the store, inventory data 335 identifying and charactering an inventory status for each item in the store and eligible media devices available for displaying advertisements in the store, device health data 336 identifying health data identifying and charactering a health status of each media device in the store, foot traffic data 337 identifying and charactering customer foot traffic associated with each media device in the store, historical ad display data 338 indicating historical data of displaying advertisements on media devices in the store.

The database 116 may also store ad generation model data 390 identifying and characterizing one or more models and related data for generating and serving in-store advertisements. For example, the ad generation model data 390 may include: an ad campaign generation model 392, a playlist generation model 394, a device management model 396, an ad billing model 398 and model training and testing data 399. In various embodiments, the ad generation model data 390 includes any number of the ad campaign generation models 392, the playlist generation models 394, the device management models 396, and the ad billing models 398.

The ad campaign generation model 392 in this example can be used to generate an advertising campaign based on a campaign reservation request for an advertiser. The advertising campaign may be created for a plurality of display channels including e.g. a physical store, an online web page, and/or a social media platform. For example, the ad campaign generation model 392 may be trained to generate an advertising campaign based on requirements and/or constraints specified by the campaign reservation request. In some examples, the requirements and/or constraints may include: a specified product item to be advertised, a required location or required physical stores to advertise the product item, a required section or department to display an advertisement, a specified time slots in a day to display the advertisement, and/or a desired displaying time or frequency per day to display the advertisement.

The playlist generation model 394 in this example can be used to generate playlist data including a playlist of advertisements associated with a time period and a physical store. In some examples, the playlist may be generated in response to a playlist request generated by the physical store. In some examples, the playlist may be generated automatically based on one or more advertising campaigns generated for one or more advertisers. For example, the playlist generation model 394 may be trained to generate playlist data based on advertising campaigns for different advertisers and device inventory information for multiple physical stores. The playlist data may include a respective playlist of advertisements that are selected from the advertising campaigns, and are to be displayed by a respective list of media devices in a respective section of each physical store within each loop time period (e.g. each hour). The advertisements may be selected based on requirements and/or constraints associated with the advertising campaigns, and based on device inventory information and other store data of the physical stores.

The device management model 396 in this example can be used to manage media devices in physical stores for displaying advertisements. In some examples, the system can use the device management model 396 to monitor each respective media device in each respective store to generate device health data of the respective media device. The system can select, based on corresponding device health data, healthy devices from the media devices in each respective store. For example, a media device is determined to be a healthy device when its corresponding device health data satisfies at least one criterion. For example, a media device is determined to be an unhealthy device and a request is automatically generated for fixing the media device, when its corresponding device health data does not satisfy the at least one criterion. The at least one criterion may be related to an unhealthy status about: processor temperature of a device, signal acknowledgement rate of a device, and/or signal response speed of a device. The at least one criterion may be associated with a predetermined time threshold regarding an unhealthy status. For example, after detecting a processor temperature higher than a degree for longer than a time threshold on a device according to the device management model 396, the system may mark the device as an unhealthy device, and generate an alert for fixing the device. In some examples, based on the device management model 396, the system can select eligible media devices from healthy devices in the physical stores. Each eligible media device is available to display advertisements in at least one available time period, and has passed the at least one criterion for health check.

The ad billing model 398 in this example can be used to generate billing data for an advertiser. In some examples, the system can collect an advertisement display history of each media device at each physical store, and estimate foot traffic data associated with the media device in the physical store during advertisement displaying time in the advertisement display history. The system may use the ad billing model 398 to generate billing information based on the advertisement display history and the estimated foot traffic data. The billing information may include respective billing data for each respective advertiser. The system can transmit the respective billing data to each respective advertiser. In some examples, billing information for a given advertisement may be determined based on: a frequency of displaying the given advertisement in a time period, and the time period. For example, the billing may be higher for a higher frequency of displaying the given advertisement in the time period. For example, the billing may be different when the time period is in different time slots of a day, or when the time period is in different days or shopping seasons.

In some embodiments, one or more of the ad campaign generation model 392, the playlist generation model 394, the device management model 396 and the ad billing model 398 can be implemented as a machine learning model, a natural language model, or a large language model. The model training and testing data 399 may include data utilized for training one or more of the ad campaign generation model 392, the playlist generation model 394, the device management model 396 and the ad billing model 398. In some examples, the model training and testing data 399 may be formed based on: item features, advertisement features, campaign features, media device features, store features, section features, historical or labelled playlist data, and historical feedback data, obtained from either real data or synthetic data.

In some embodiments, the in-store advertisement computing device 102 may assign one or more of the above described operations to a different processing unit or virtual machine hosted by one or more processing devices 120. Further, the in-store advertisement computing device 102 may obtain the outputs of these assigned operations from the processing units, and generate the campaign data 312, the billing data 318 and/or the playlist data 316 based on the outputs.

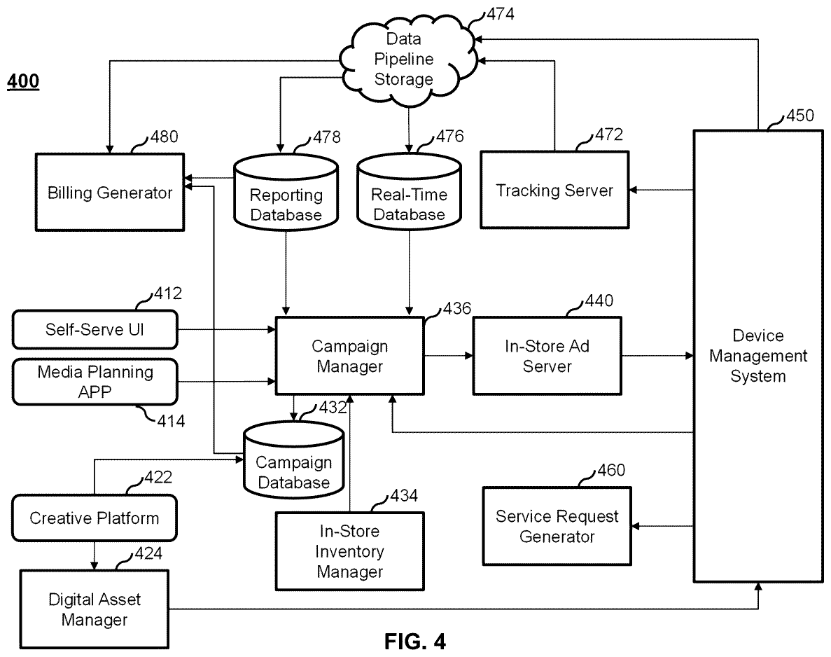

FIG. 4 illustrates an example architecture of a system for generating and serving in-store advertisements, in accordance with some embodiments. In some embodiments, the system 400 can be implemented by one or more computing devices, such as the in-store advertisement computing device 102, the server 104, the physical stores 109 and/or the cloud-based engine 121 of FIG. 1.

As shown in FIG. 4, the system 400 in this example includes a campaign manager 436, an in-store inventory manager 434, a digital asset manager 424, an in-store ad server 440, a device management system 450, a service request generator 460, a tracking server 472 and a billing generator 480. In some embodiments, the campaign manager 436 may receive campaign reservation requests from various sources.

In some examples, an advertiser may submit a campaign reservation request via a self-serve user interface (UI) 412 to the campaign manager 436. The self-serve UI 412 may show various information related to campaign creation, e.g. a list of stores, media device inventory availability at different stores, displaying time availability, pricing information, etc., to the advertiser. In some embodiments, the media device inventory availability is provided by the in-store inventory manager 434 to indicate how many media devices are arranged or located in each store, or in each section of the store. The campaign reservation request submitted by the advertiser may be generated based on the displayed information to specify a desired store, day, time, and/or location to create a corresponding campaign. In some examples, after the campaign manager 436 receives a user selection from the advertiser via the self-serve UI 412, the campaign manager 436 generates the various information related to campaign creation by querying the in-store inventory manager 434, and displays the various information to the advertiser via the self-serve UI 412 before receiving the campaign reservation request. In some examples, the campaign manager 436 receives the campaign reservation request from the advertiser via the self-serve UI 412 before querying the in-store inventory manager 434, then either creates a campaign or rejects the campaign reservation request based on the various information related to campaign creation.

In some examples, an advertiser may work with a service team to generate and submit the campaign reservation request. In some examples, an advertiser may merely indicate a desire to create a campaign for a specified product via a media planning application 414. The media planning application 414 can automatically query information related to campaign creation, e.g. through the campaign manager 436 and the in-store inventory manager 434, and then automatically generate a campaign reservation request for the advertiser regarding the specified product based on the information related to campaign creation.

Upon receiving a campaign reservation request from the self-serve UI 412 or the media planning application 414, the campaign manager 436 can create an advertising campaign based on the campaign reservation request. The created campaign may be associated with a specified store, day, time, and/or location. For example, the created campaign may run from time A to time B on every Saturday and Sunday for a month, targeting a list of stores in a region (e.g. west coast of the United States) and a specified section (e.g. electronics) in these stores to display advertisements from the campaign for the specified product. In some examples, the created campaign may also specify a target device type, e.g. a type (e.g. related to device resolution, device brand, device model, loop policy, etc.) of media devices required to display the advertisements in the campaign. Once such a campaign is defined and generated, the campaign manager 436 may store the campaign in a campaign database 432, which may be part of the database 116 or a standalone database.

In some embodiments, each campaign stored in the campaign database 432 is associated with one or more advertisements, whose content has been pre-created at a creative platform 422. Each campaign may be thus stored in association with the advertisement content, or in association with one or more links for retrieving the advertisement content from the creative platform 422.

In some embodiments, the content created for an advertisement at the creative platform 422 may be the same for a plurality of display channels including e.g.: a store, an online web page, or a social media platform. In some examples, different channels may have different technical specs or format requirements for the advertisement content. For example, different retailers or advertisement platforms may have different format requirements regarding the video, image and/or closed caption related to the advertisements to be displayed. The digital asset manager 424 in this example can encode advertisement content in formats and resolutions in accordance with requirements associated with different platforms. For example, the digital asset manager 424 may encode the advertisement content according to formats required by a retailer, store or media device associated with the device management system 450, and make the advertisement content available for the device management system 450 to retrieve.

In some embodiments, an advertiser can interact with the creative platform 422 to edit, modify and upload content creatives for an advertisement. For example, the advertiser may update a title of the advertisement, review and visually manage the advertisement. In some embodiments, the campaign database 432 may store different versions of the advertisement encoded in different formats for a same campaign. In some embodiments, the campaign database 432 may store a generic version of the advertisement for a campaign, and the digital asset manager 424 will encode the generic version into different formats upon a request from the device management system 450.

The in-store ad server 440 in this example may generate playlist data indicating a playlist of advertisements associated with a time period and a physical store. In some embodiments, the playlist data is generated based on at least one advertising campaign created by the campaign manager 436 and based on inventory information associated with media devices in different stores. For example, the campaign manager 436 may obtain inventory information indicating eligible media devices for displaying advertisements in physical stores during available time periods, and send the inventory information indicating device inventory availability to the in-store ad server 440. The inventory information reflects dynamic and real-time device inventory availability, rather than static device inventory availability stored by the in-store inventory manager 434. For example, while the in-store inventory manager 434 can determine how many media devices are located in a physical store, only the device management system 450 can provide real-time information regarding which of the media devices is eligible to display advertisements at a given time based on e.g. device health data being monitored for each device, control function enablement status at each device, etc.

In some embodiments, based on the real-time device inventory information and the at least one advertising campaign, the in-store ad server 440 may select the physical store (e.g. a store associated with the device management system 450) from physical stores in a store network of a retailer. In some examples, the in-store ad server 440 may select the physical store because of a playlist request transmitted from the device management system 450 to the in-store ad server 440, where the playlist request is transmitted periodically (e.g. every hour or every ten minutes) to query for a list of advertisements to be displayed in the physical store within each periodic time length (e.g. every hour during store operation time). In some examples, the in-store ad server 440 may select the physical store without any request from any store, and based on a match between the real-time device inventory information of the physical store and specified criteria in the at least one advertising campaign.

In some embodiments, based on the at least one advertising campaign, the in-store ad server 440 can determine a section of the physical store. The section may be associated with a product department or a product category in the physical store. For example, when a product to be advertised by the at least one advertising campaign is an electronic device, the section may be electronics department; and when the product to be advertised by the at least one advertising campaign is a piece of clothes, the section may be clothes department.

In some embodiments, for each of the at least one advertising campaign, the in-store ad server 440 can determine at least one campaign criterion that is associated with: at least one product category, at least one time period, and at least one physical store. The in-store ad server 440 can select the physical store as a physical store that is shared by the at least one advertising campaign, and determine a section that is associated with a product category shared by the at least one advertising campaign and is open in a time period shared by the at least one advertising campaign. The in-store ad server 440 may then generate the playlist of advertisements to be displayed in the section of the physical store within the time period.

In some embodiments, based on the real-time device inventory information and the at least one advertising campaign, the in-store ad server 440 can select one or more media devices from eligible media devices located in the section of the physical store, and generate the list of advertisements based on the at least one advertising campaign and the real-time device inventory information of the one or more media devices. The in-store ad server 440 may transmit the list of advertisements to the device management system 450 associated with the physical store and/or the section, to display the list of advertisements according to playlist data specifying the displaying time, section, frequency, etc.

In some embodiments, the device management system 450 may receive a playlist from the in-store ad server 440 periodically (e.g. every hour or every ten minutes) and manage devices in a corresponding section of the physical store to display advertisements according to the playlist. In some examples, the device management system 450 may keep monitoring each respective media device in the physical store to generate device health data of the respective media device, and select, based on corresponding device health data, healthy devices from the media devices in the physical store. For example, a media device is a healthy device when its corresponding device health data satisfies at least one criterion, and is an unhealthy device when its corresponding device health data does not satisfy the at least one criterion.

In some embodiments, the device management system 450 may automatically generate and send an alert to the service request generator 460 to indicate that an unhealthy device has been unhealthy for longer than a predetermined time period (e.g. four hours). The service request generator 460 can then automatically generate a service request (e.g. a service ticket) for fixing the unhealthy device.

In some embodiments, the device management system 450 may select the eligible media devices from the healthy devices in the physical store, where each of the eligible media devices is available to display advertisements in at least one of the available time periods. The device management system 450 may send the real-time monitoring information of the eligible media devices or all media devices of the physical store to the campaign manager 436 for playlist generation.

In some embodiments, the playlist data received by the device management system 450 includes indications of the time period and a section of the physical store; and includes an ordered list of addresses for the playlist of advertisements, respectively. Each address may be a network address or link (e.g. uniform resource locators or URLs) corresponding to a version of an advertisement whose format is compatible with a requirement associated with the section of the physical store. The device management system 450 may retrieve a corresponding version of each advertisement in the playlist based on a corresponding address, e.g. from the digital asset manager 424, and play these advertisements according to the order specified by the playlist on eligible media devices in the section. In some embodiments, am eligible media device is a media device with a consumer electronics control function enabled, such that the media device can be automatically powered on and switched to a corresponding input port for displaying the playlist of advertisements once upon receiving the playlist data.

In some embodiments, the tracking server 472 can collect an advertisement display history of one or more media devices managed by the device management system 450. The advertisement display history may indicate advertisement content played during each time period in the history for each media device. In some examples, the tracking server 472 can track and clean the advertisement display history e.g. by removing duplicate records from multiple devices, and store data of the advertisement display history in a data pipeline storage 474, which may be part of the database 116 or a standalone database.

In some embodiments, the device management system 450 can also estimate foot traffic data associated with the one or more media devices managed by the device management system 450 during the advertisement display history, and store the foot traffic data in the data pipeline storage 474. The foot traffic data may be an indication of a quantity of impressions of advertisements displayed by the one or more media devices in the advertisement display history.

In some embodiments, a real-time database 476 in the system 400 can store real-time reporting data for advertisement display from the data pipeline storage 474, while a reporting database 478 in the system 400 can store updated reporting data where the reporting data for advertisement display has been updated and reviewed to guarantee accuracy for billing purposes. As such, if there is any missing data or beacons being caught up during a daily update, the reporting database 478 can always reflect the corrected data for billing.

In the example shown in FIG. 4, data in both the real-time database 476 and the reporting database 478 are utilized by the campaign manager 436 to create advertising campaigns. In contrast, only data from the reporting database 478, rather than the real-time database 476, is utilized by the billing generator 480 to generate billing data. For example, the billing generator 480 can generate billing information based on the advertisement display history and the estimated foot traffic data, and transmit the billing information to at least one advertiser. The billing information for a given advertisement may be determined based on: a frequency of displaying the given advertisement in a time period, and features of the time period itself.

In some embodiments, data in the real-time database 476 and the reporting database 478 can be utilized as feedback to the campaign manager 436 for updating a campaign, thereby updating a corresponding playlist. For example, a campaign created by the campaign manager 436 for an advertiser requests to run an advertisement four times per hour. That is, the campaign has an expected display frequency. In some situations, the campaign manager 436 determines, based on real-time reporting data in the real-time database 476, that an actual display frequency of the advertisement is different from the expected display frequency, e.g. three times per hour rather than four times per hour as expected. This may happen when some store was down or some device had a technical issue. In these situations, the campaign manager 436 can update the campaign by adjusting the display frequency to match the expected value, while the campaign is in progress.

In some embodiments, the system 400 is a guaranteed delivery system for an advertiser, which means the system 400 will show advertisements as many times as the advertiser requested and in accordance with the time, location, section, and store requirements associated with the campaign reservation request for the advertiser. In these embodiments, the billing information for the advertiser may be generated based on the data pipeline storage 474, the reporting database 478 and campaign data stored in the campaign database 432 for the advertiser.

In some embodiments, the system 400 is a non-guaranteed delivery system for an advertiser, which means the system 400 may or may not show advertisements as requested by the advertiser. For example, when other advertisers are requesting other campaigns, whether the advertiser's campaign can run as requested will depend on a bidding process performed regarding the advertiser's campaign and other campaigns sharing a common physical store and a common display time period. In these embodiments, the billing information for the advertiser may be generated based on the bidding results, in addition to the data pipeline storage 474, the reporting database 478 and campaign data stored in the campaign database 432 for the advertiser.

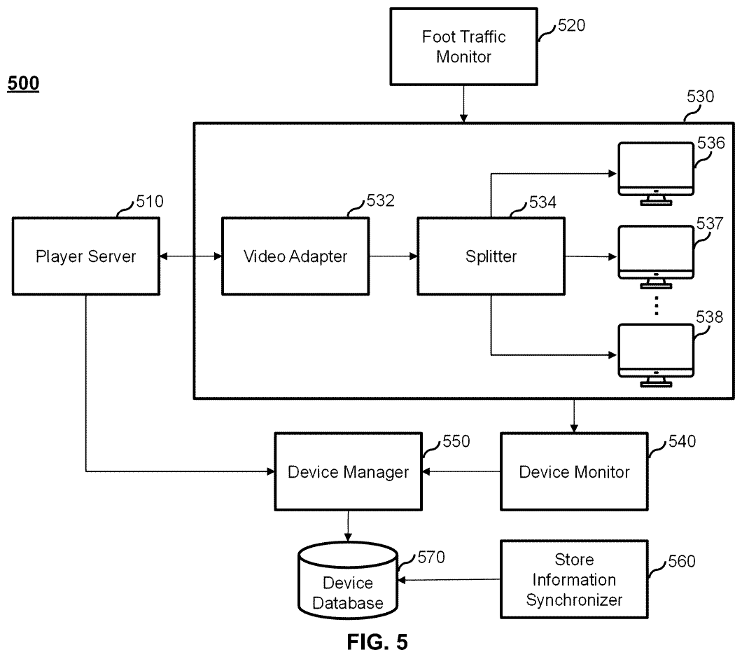

FIG. 5 is a block diagram illustrating various portions of a device management system 500, in accordance with some embodiments. In some embodiments, the device management system 500 may be incorporated as the device management system 450 in the system 400 of FIG. 4. In some embodiments, the device management system 500 can be implemented by one or more computing devices, such as the in-store advertisement computing device 102, the physical stores 109 and/or the cloud-based engine 121 of FIG. 1.

As shown in FIG. 5, the device management system 500 in this example includes a player server 510, a foot traffic monitor 520, an example section 530, a device monitor 540, a device manager 550 and a store information synchronizer 560. As shown in FIG. 5, the example section 530 may include a video adapter 532, a splitter 534 and media devices 536, 537, 538.

In some examples, the player server 510 is associated with the example section 530, which is a section of a physical store, e.g. a product department in the store. In some examples, the player server 510 may periodically send a request to an ad server, e.g. the in-store ad server 440 in FIG. 4, to ask for playlist data to display a playlist of advertisements for a future time period (e.g. the next hour). In some examples, the player server 510 may periodically receive the playlist of advertisements from the ad server. Upon receiving the playlist, the player server 510 may send the playlist data to the video adapter 532 for video adaptation. In addition, the player server 510 can send the playlist data to the device manager 550 for device management.

In some embodiments, the playlist data includes indications of a time period, a physical store and the example section 530 of the physical store. In some embodiments, the playlist data is directed to the media devices 536, 537, 538 located in the example section 530 of the physical store, for displaying the playlist of advertisements on the media devices 536, 537, 538 within the time period specified in the playlist data. In some embodiments, the playlist data includes an ordered list of addresses for the playlist of advertisements, respectively. Each address may be a network link or address corresponding to a version of an advertisement whose format is compatible with a requirement associated with the example section 530 of the physical store. In some examples, the player server 510 may retrieve and download each advertisement in the playlist from a corresponding address at the digital asset manager 424, and send the downloaded advertisements to the media devices 536, 537, 538 for displaying according to the order specified by the playlist. In some embodiments, each of the media devices 536, 537, 538 downloads the advertisements by itself after receiving the playlist.

In some embodiments, the downloaded advertisement content is first cached before being displayed on the media devices 536, 537, 538. This can ensure no delay between content switching on the media devices 536, 537, 538, and no buffering time is needed at the media devices 536, 537, 538. In some embodiments, each of the media devices 536, 537, 538 can switch between web apps and streaming.

The video adapter 532 in this example may be an optional device configured to update the image/video format of each advertisement in the playlist to be compatible with the operation systems running on the media devices 536, 537, 538. In some embodiments, the video adapter 532 may be integrated into each of the media devices 536, 537, 538, rather than a separate device. In some embodiments, the splitter 534 may split the image/video signal received from the video adapter 532 or directly from the player server 510, and send the split signals to the media devices 536, 537, 538 to run the playlist at the same time. The media devices 536, 537, 538 may be synchronized to play each advertisement in the playlist simultaneously.

In some embodiments, each of the media devices 536, 537, 538 has been enabled a consumer electronics control (CEC) function, such that each media device is automatically powered on and switched to a corresponding input port for displaying the playlist of advertisements once upon receiving the playlist data.

The device monitor 540 in this example may monitor each of the media devices 536, 537, 538 in the example section 530, and generate device health data for each media device. The device monitor 540 may send the device health data to the device manager 550 for device management. In some embodiments, each of the media devices 536, 537, 538 is registered with the device manager 550 through the player server 510.

The device manager 550 may receive the device health data from the device monitor 540, and receive the playlist data from the player server 510. Based on the device health data of each media device and the playlist data, the device manager 550 can determine whether the media device is a healthy device or an unhealthy device. For example, a media device is determined to be a healthy device when its corresponding device health data satisfies at least one criterion, and is determined to be an unhealthy device when its corresponding device health data does not satisfy the at least one criterion. The device health data of a media device may be related to: whether the media device is powered on, whether the media device has a CEC function enabled, a processor temperature of the media device, a signal acknowledgement rate of the media device, a signal response speed of the media device, how many advertisements downloaded for the media device, and/or how many advertisements displayed on the media device. A media device is in an unhealthy status when: e.g. a processor temperature of the media device is higher than a degree, a signal response speed of the media device is lower than a threshold, the media device is not powered on, the media device has no CEC function enabled, or no device health data is received for the media device. A media device may also be in an unhealthy status when: a difference between the downloaded advertisements and displayed advertisements for the media device is larger than a threshold, or a difference between an expected display frequency (based on the playlist data) and an actual display frequency (based on the device health data) for an advertisement is larger than a threshold. A media device may be determined to be an unhealthy device when it is in the unhealthy status for longer than a predetermined time period according to the at least one criterion. After detecting that a media device's unhealthy status is longer than the predetermined time period, the device manager 550 may mark the media device as an unhealthy device. Then, the device manager 550 can generate and send an alert, e.g. to the service request generator 460 in FIG. 4, for fixing the unhealthy device. In some embodiments, the device manager 550 may store the device health data of each media device into a device database 570, which may be part of the database 116 or a standalone database.

In some embodiments, the device monitor 540, the device manager 550 and the device database 570 are associated with multiple sections of multiple stores. For example, the device monitor 540 may monitor each respective media device in each respective store of the multiple stores to generate device health data of the respective media device. The device manager 550 can determine healthy devices in each section of the multiple stores, and select eligible media devices from the healthy devices in each section. Each of the eligible media devices is available to display advertisements in at least one of available time periods. The device manager 550 may store inventory information of the eligible media devices for each section in the device database 570. The inventory information of a media device may indicate the time slots when the media device is available to display advertisements.

In some embodiments, the device management system 500 may send a cached copy of the inventory information for each section in each store to the in-store inventory manager 434 periodically. Even when the in-store inventory manager 434 cannot get an updated cache, the in-store inventory manager 434 can provide an older version of the cache to the campaign manager 436 for creating a campaign, and for the in-store ad server 440 to generate a playlist. The in-store ad server 440 can always generate a playlist whenever receiving a playlist request from the player server 510 or the device management system 450.

In some embodiments, a respective player server is associated with each section of each store, such that different sections are handled by different player servers. In some embodiments, a same section may be divided into multiple sub-sections, each of which is handled by a different player server, such that media devices in different sub-sections of the same section can display advertisements according to different playlists.

In some embodiments, the device database 570 also receives store synchronization data from the store information synchronizer 560. In some examples, the store synchronization data may include store level information like: store ID of each store, manager ID of the store, contact information of the store, operation hours of the store, device inventory availability in each section of the store, etc. In some examples, a store manager may change inventory availability of devices in a store, or temporarily change store operation time for the store, by changing the store synchronization data for the store.

In some embodiments, the device database 570 includes different cached copies of device data and store data, each copy corresponding to a historical time point. In some examples, an ad server, e.g. the in-store ad server 440 in FIG. 4, may obtain a cached copy of data related to all stores of a retailer from the device database 570, to generate a playlist. This can ensure that the playlist does not include an advertisement scheduled to be displayed in a store when the store is closed. In some examples, the campaign manager 436 in FIG. 4 may utilize a cached copy of store data in the device database 570 to generate a campaign. As such, the campaign can be determined to run a certain number of times per hour during a time window while a corresponding store is open. The ad server may further determine a playlist involving the campaign at media device level based on a cached copy of device data in the device database 570.

In some embodiments, the player server 510 may also transmit an advertisement display history of the media devices 536, 537, 538 in the example section 530 to a tracking server, e.g. the tracking server 472 in FIG. 4, for tracking, reporting, and billing purposes.

In some embodiments, the foot traffic monitor 520 may estimate foot traffic data associated with each of the media devices 536, 537, 538 in the example section 530. For example, using one or more sensors or cameras, the foot traffic monitor 520 may determine how many people were in the example section 530 when an advertisement was being played by the media devices 536, 537, 538. This can give an estimated impression data of the advertisement. In some embodiments, foot traffic monitor 520 may send the foot traffic data to the data pipeline storage 474 in FIG. 4 to be utilized to generate the billing information for the advertisement.

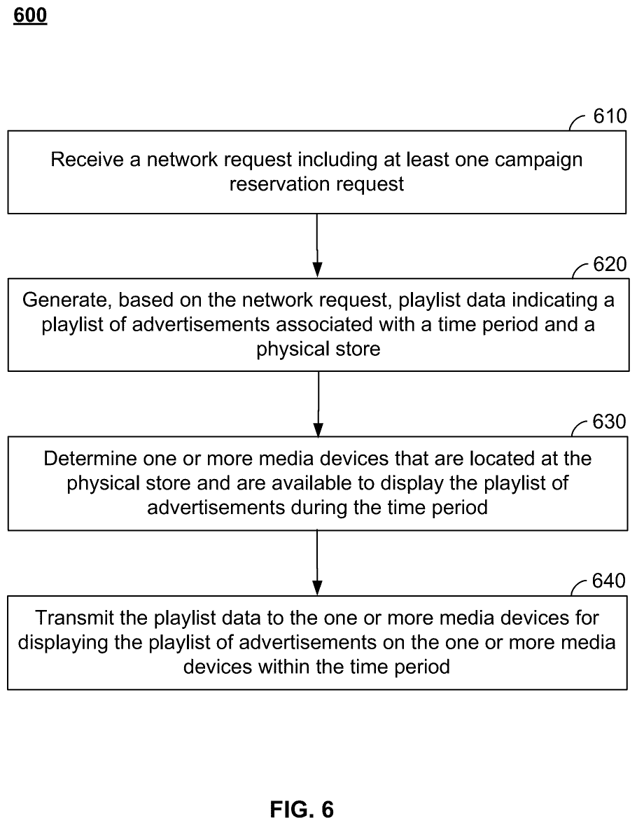

FIG. 6 shows a flowchart illustrating an example method 600 for generating and serving in-store advertisements, in accordance with some embodiments. In some embodiments, the method 600 can be carried out by a system including one or more computing devices, such as the in-store advertisement computing device 102 and/or the cloud-based engine 121 of FIG. 1. Beginning at operation 610, a network request including at least one campaign reservation request is received. At operation 620, based on the network request, playlist data is generated to indicate a playlist of advertisements associated with a time period and a physical store. At operation 630, one or more media devices are determined to be located at the physical store and are available to display the playlist of advertisements during the time period. At operation 640, the playlist data is transmitted to the one or more media devices for displaying the playlist of advertisements on the one or more media devices within the time period.

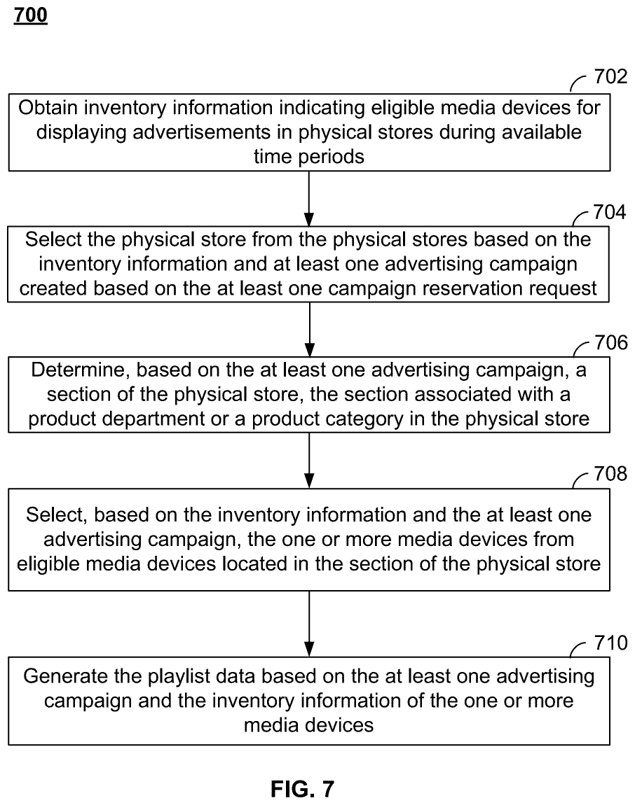

FIG. 7 shows a flowchart illustrating an example method 700 for generating playlist data, in accordance with some embodiments. In some embodiments, the method 700 can be carried out by a system including one or more computing devices, such as the in-store advertisement computing device 102 and/or the cloud-based engine 121 of FIG. 1. In some embodiments, the method 700 can be performed as part of the operation 620 of the example method 600 in FIG. 6. Beginning at operation 702, inventory information is obtained to indicate eligible media devices for displaying advertisements in physical stores during available time periods. At operation 704, the physical store is selected from the physical stores based on the inventory information and at least one advertising campaign created based on the at least one campaign reservation request. At operation 706, based on the at least one advertising campaign, a section of the physical store is determined. The section is associated with a product department, a product category, a specified brand or a specified location in the physical store. At operation 708, based on the inventory information and the at least one advertising campaign, the one or more media devices are selected from eligible media devices located in the section of the physical store. At operation 710, the playlist data is generated based on the at least one advertising campaign and the inventory information of the one or more media devices.

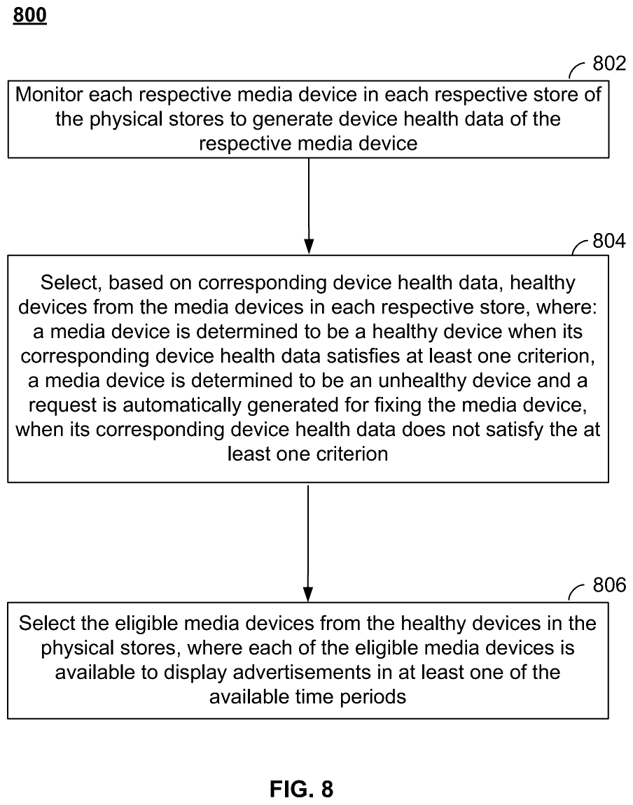

FIG. 8 shows a flowchart illustrating an example method 800 for obtaining inventory information, in accordance with some embodiments. In some embodiments, the method 800 can be carried out by a system including one or more computing devices, such as the in-store advertisement computing device 102 and/or the cloud-based engine 121 of FIG. 1. In some embodiments, the method 800 can be performed as part of the operation 702 of the example method 700 in FIG. 7. Beginning at operation 802, each respective media device is monitored in each respective store of the physical stores to generate device health data of the respective media device. At operation 804, based on corresponding device health data, healthy devices are selected from the media devices in each respective store. A media device is determined to be a healthy device when its corresponding device health data satisfies at least one criterion. A media device is determined to be an unhealthy device and a request is automatically generated for fixing the media device, when its corresponding device health data does not satisfy the at least one criterion. At operation 806, the eligible media devices are selected from the healthy devices in the physical stores. Each of the eligible media devices is available to display advertisements in at least one of the available time periods.

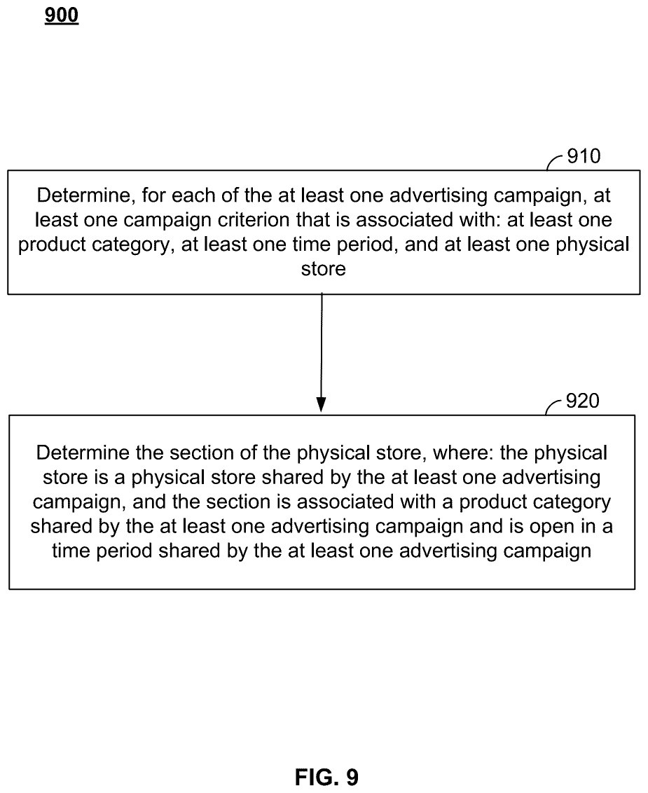

FIG. 9 shows a flowchart illustrating an example method 900 for determining a section of a physical store, in accordance with some embodiments. In some embodiments, the method 900 can be carried out by a system including one or more computing devices, such as the in-store advertisement computing device 102 and/or the cloud-based engine 121 of FIG. 1. In some embodiments, the method 900 can be performed as part of the operation 706 of the example method 700 in FIG. 7. Beginning at operation 910, for each of the at least one advertising campaign, at least one campaign criterion is determined to be associated with: at least one product category, at least one time period, and at least one physical store. At operation 920, the section of the physical store is determined. The physical store is a physical store shared by the at least one advertising campaign. The section is associated with a product category shared by the at least one advertising campaign and is open in a time period shared by the at least one advertising campaign.

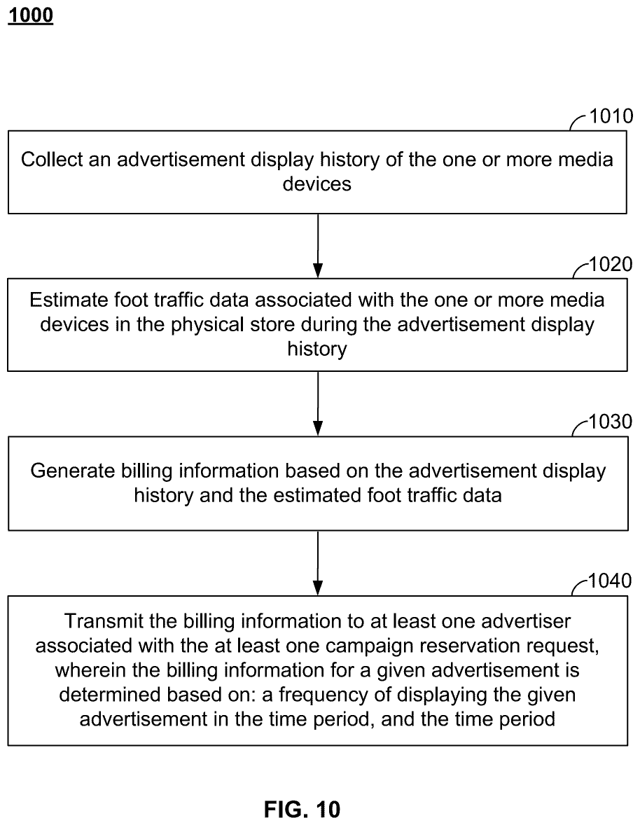

FIG. 10 shows a flowchart illustrating an example method 1000 for generating and transmitting billing information, in accordance with some embodiments. In some embodiments, the method 1000 can be carried out by a system including one or more computing devices, such as the in-store advertisement computing device 102 and/or the cloud-based engine 121 of FIG. 1. Beginning at operation 1010, an advertisement display history of the one or more media devices is collected. At operation 1020, foot traffic data associated with the one or more media devices is estimated in the physical store during the advertisement display history. At operation 1030, billing information is generated based on the advertisement display history and the estimated foot traffic data. At operation 1040, the billing information is transmitted to at least one advertiser associated with the at least one campaign reservation request. The billing information for a given advertisement is determined based on: a frequency of displaying the given advertisement in the time period, and the time period.

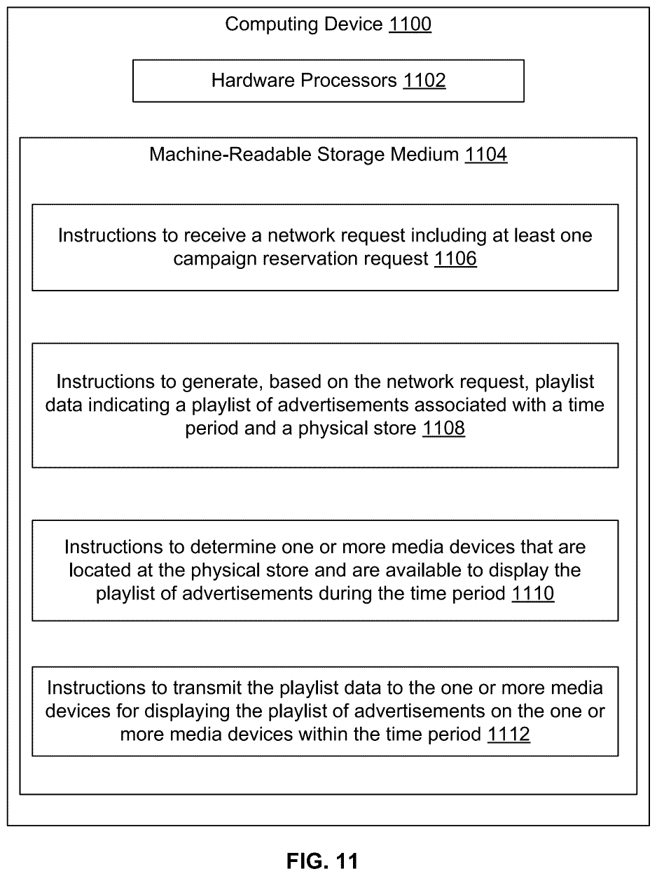

FIG. 11 depicts an example system 1100 (e.g. a computing device) for generating and serving in-store advertisements, including a machine-readable medium 1104 encoded with example instructions executable by processing resource 1102, e.g. hardware processors, in accordance with some embodiments. In some implementations, the system 1100 may be useful for implementing aspects of the system 400 of FIG. 4. In some implementations, functionality described with respect to FIG. 4 may be included in the instructions encoded on machine-readable medium 1104.

The processing resource 1102 may include a microcontroller, a microprocessor, central processing unit core(s), an ASIC, an FPGA, and/or other hardware device suitable for retrieval and/or execution of instructions from the machine-readable medium 1104 to perform functions related to various examples. Additionally or alternatively, the processing resource 1102 may include or be coupled to electronic circuitry or dedicated logic for performing some or all of the functionality of the instructions described herein.

The machine-readable medium 1104 may be any medium suitable for storing executable instructions, such as RAM, ROM, EEPROM, flash memory, a hard disk drive, an optical disc, or the like. In some example implementations, the machine-readable medium 1104 may be a tangible, non-transitory medium. The machine-readable medium 1104 may be disposed within the system 1100 in which case the executable instructions may be deemed installed or embedded on the system. Alternatively, the machine-readable medium 1104 may be a portable (e.g., external) storage medium, and may be part of an installation package.

As described further herein below, the machine-readable medium 1104 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 11.

The machine-readable medium 1104 includes instructions 1106-1112. Instructions 1106, when executed, cause the processing resource 1102 to receive a network request including at least one campaign reservation request. The instructions 1108, when executed, cause the processing resource 1102 to generate, based on the network request, playlist data indicating a playlist of advertisements associated with a time period and a physical store.

Instructions 1110, when executed, cause the processing resource 1102 to determine one or more media devices that are located at the physical store and are available to display the playlist of advertisements during the time period. The instructions 1112, when executed, cause the processing resource 1102 to transmit the playlist data to the one or more media devices for displaying the playlist of advertisements on the one or more media devices within the time period.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of example embodiments, it is not limited thereto. Rather, the appended claims should be construed broadly, to include other variants and embodiments, which can be made by those skilled in the art.

1. A system, comprising:
a processor; and
a non-transitory memory storing instructions, that when executed, cause the processor to:
receive a network request including at least one campaign reservation request;
generate, based on the network request, playlist data indicating a playlist of advertisements associated with a time period and a physical store;
determine a section of the physical store based on the at least one advertising campaign;
select one or more media devices from eligible media devices that are located in the section of the physical store and are available to display the playlist of advertisements during the time period, wherein e ach of the one or more media devices is capable of being automatically powered on and switched to a corresponding input port for displaying the playlist of advertisements upon receiving the playlist data; and
transmit the playlist data to the one or more media devices, the playlist data instructing the one or more media devices to be automatically powered on and switched to the corresponding input port for displaying the playlist of advertisements within the time period.

2. The system of claim 1, wherein:
at least one advertising campaign is created via a user interface or created by the processor automatically based on the at least one campaign reservation request; and
the at least one advertising campaign is created for a plurality of display channels including at least one of: a store, an online web page, or a social media platform.

3. The system of claim 2, wherein the playlist data is generated based on:
obtaining inventory information indicating eligible media devices for displaying advertisements in physical stores during available time periods;
selecting the physical store from the physical stores based on the inventory information and the at least one advertising campaign;
determining, based on the at least one advertising campaign, a section of the physical store, wherein the section is associated with a product department or a product category in the physical store;
selecting, based on the inventory information and the at least one advertising campaign, the one or more media devices from eligible media devices located in the section of the physical store; and
generating the playlist data based on the at least one advertising campaign and the inventory information of the one or more media devices.

4. The system of claim 3, wherein obtaining the inventory information comprises:
monitoring each respective media device in each respective store of the physical stores to generate device health data of the respective media device;
selecting, based on corresponding device health data, healthy devices from the media devices in each respective store, wherein:
a media device is determined to be a healthy device when its corresponding device health data satisfies at least one criterion,
a media device is determined to be an unhealthy device and a request is automatically generated for fixing the media device, when its corresponding device health data does not satisfy the at least one criterion; and
selecting the eligible media devices from the healthy devices in the physical stores, wherein:
each of the eligible media devices is available to display advertisements in at least one of the available time periods.

5. The system of claim 3, wherein determining the section of the physical store comprises:
determining, for each of the at least one advertising campaign, at least one campaign criterion that is associated with: at least one product category, at least one time period, and at least one physical store; and
determining the section of the physical store, wherein:
the physical store is a physical store shared by the at least one advertising campaign, and
the section is associated with a product category shared by the at least one advertising campaign and is open in a time period shared by the at least one advertising campaign.

6. The system of claim 1, wherein the playlist data includes:
indications of the time period and a section of the physical store; and
an ordered list of addresses for the playlist of advertisements, respectively, wherein each address corresponds to a version of an advertisement whose format is compatible with a requirement associated with the section of the physical store.

7. The system of claim 1, wherein:
each of the one or more media devices has been enabled a consumer electronics control function, such that the media device is automatically powered on and switched to a corresponding input port for displaying the playlist of advertisements once upon receiving the playlist data.

8. The system of claim 1, wherein the instructions, when executed, further cause the processor to:
collect an advertisement display history of the one or more media devices;
estimate foot traffic data associated with the one or more media devices in the physical store during the advertisement display history;
generate billing information based on the advertisement display history and the estimated foot traffic data; and
transmit the billing information to at least one advertiser associated with the at least one campaign reservation request, wherein the billing information for a given advertisement is determined based on: a frequency of displaying the given advertisement in the time period, and the time period.

9. A computer-implemented method, comprising:
receiving a network request including at least one campaign reservation request;
generating, based on the network request, playlist data indicating a playlist of advertisements associated with a time period and a physical store;
determining a section of the physical store based on the at least one advertising campaign;
selecting one or more media devices from eligible media devices that are located in the section of the physical store and are available to display the playlist of advertisements during the time period, wherein each of the one or more media devices is capable of being automatically powered on and switched to a corresponding input port for displaying the playlist of advertisements upon receiving the playlist data; and
transmitting the playlist data to the one or more media devices, the playlist data instructing the one or more media devices to be automatically powered on and switched to the corresponding input port for displaying the playlist of advertisements within the time period.

10. The computer-implemented method of claim 9, wherein:
at least one advertising campaign is created via a user interface or created by the processor automatically based on the at least one campaign reservation request; and
the at least one advertising campaign is created for a plurality of display channels including at least one of: a store, an online web page, or a social media platform.

11. The computer-implemented method of claim 10, wherein generating the playlist data comprises:
obtaining inventory information indicating eligible media devices for displaying advertisements in physical stores during available time periods;
selecting the physical store from the physical stores based on the inventory information and the at least one advertising campaign;
determining, based on the at least one advertising campaign, a section of the physical store, wherein the section is associated with a product department or a product category in the physical store;
selecting, based on the inventory information and the at least one advertising campaign, the one or more media devices from eligible media devices located in the section of the physical store; and
generating the playlist data based on the at least one advertising campaign and the inventory information of the one or more media devices.

12. The computer-implemented method of claim 11, wherein obtaining the inventory information comprises:
monitoring each respective media device in each respective store of the physical stores to generate device health data of the respective media device;
selecting, based on corresponding device health data, healthy devices from the media devices in each respective store, wherein:
a media device is determined to be a healthy device when its corresponding device health data satisfies at least one criterion,
a media device is determined to be an unhealthy device and a request is automatically generated for fixing the media device, when its corresponding device health data does not satisfy the at least one criterion; and
selecting the eligible media devices from the healthy devices in the physical stores, wherein:
each of the eligible media devices is available to display advertisements in at least one of the available time periods.

13. The computer-implemented method of claim 11, wherein determining the section of the physical store comprises:
determining, for each of the at least one advertising campaign, at least one campaign criterion that is associated with: at least one product category, at least one time period, and at least one physical store; and
determining the section of the physical store, wherein:
the physical store is a physical store shared by the at least one advertising campaign, and
the section is associated with a product category shared by the at least one advertising campaign and is open in a time period shared by the at least one advertising campaign.

14. The computer-implemented method of claim 9, wherein the playlist data includes:
indications of the time period and a section of the physical store; and
an ordered list of addresses for the playlist of advertisements, respectively, wherein each address corresponds to a version of an advertisement whose format is compatible with a requirement associated with the section of the physical store.

15. The computer-implemented method of claim 9, wherein:
each of the one or more media devices has been enabled a consumer electronics control function, such that the media device is automatically powered on and switched to a corresponding input port for displaying the playlist of advertisements once upon receiving the playlist data.

16. The computer-implemented method of claim 9, further comprising:
collecting an advertisement display history of the one or more media devices;
estimating foot traffic data associated with the one or more media devices in the physical store during the advertisement display history;
generating billing information based on the advertisement display history and the estimated foot traffic data; and
transmitting the billing information to at least one advertiser associated with the at least one campaign reservation request, wherein the billing information for a given advertisement is determined based on: a frequency of displaying the given advertisement in the time period, and the time period.

17. A non-transitory computer readable medium having instructions stored thereon, wherein the instructions, when executed by at least one processor, cause at least one device to perform operations comprising:
receiving a network request including at least one campaign reservation request;
generating, based on the network request, playlist data indicating a playlist of advertisements associated with a time period and a physical store;
determining a section of the physical store based on the at least one advertising campaign;
selecting one or more media devices from eligible media devices that are located in the section of the physical store and are available to display the playlist of advertisements during the time period, wherein each of the one or more media devices is capable of being automatically powered on and switched to a corresponding input port for displaying the playlist of advertisements upon receiving the playlist data; and
transmitting the playlist data to the one or more media devices, the playlist data instructing the one or more media devices to be automatically powered on and switched to the corresponding input port for displaying the playlist of advertisements within the time period.

18. The non-transitory computer readable medium of claim 17, wherein generating the playlist data comprises:
obtaining inventory information indicating eligible media devices for displaying advertisements in physical stores during available time periods, wherein at least one advertising campaign is created via a user interface or created by a processor automatically based on the at least one campaign reservation request;
selecting the physical store from the physical stores based on the inventory information and the at least one advertising campaign;
determining, based on the at least one advertising campaign, a section of the physical store, wherein the section is associated with a product department or a product category in the physical store;
selecting, based on the inventory information and the at least one advertising campaign, the one or more media devices from eligible media devices located in the section of the physical store; and
generating the playlist data based on the at least one advertising campaign and the inventory information of the one or more media devices.

19. The non-transitory computer readable medium of claim 18, wherein obtaining the inventory information comprises:
monitoring each respective media device in each respective store of the physical stores to generate device health data of the respective media device;
selecting, based on corresponding device health data, healthy devices from the media devices in each respective store, wherein:
a media device is determined to be a healthy device when its corresponding device health data satisfies at least one criterion,
a media device is determined to be an unhealthy device and a request is automatically generated for fixing the media device, when its corresponding device health data does not satisfy the at least one criterion; and
selecting the eligible media devices from the healthy devices in the physical stores, wherein:
each of the eligible media devices is available to display advertisements in at least one of the available time periods.

20. The non-transitory computer readable medium of claim 18, wherein determining the section of the physical store comprises:
determining, for each of the at least one advertising campaign, at least one campaign criterion that is associated with: at least one product category, at least one time period, and at least one physical store; and
determining the section of the physical store, wherein:
the physical store is a physical store shared by the at least one advertising campaign, and
the section is associated with a product category shared by the at least one advertising campaign and is open in a time period shared by the at least one advertising campaign.
